(19) United States
(12) Patent Application Publication
(10) Pub. No.: US 2015/0067734 A1
(43) Pub. Date: Mar. 5, 2015

(54) INFORMATION DISPLAY APPARATUS, INFORMATION DISPLAY METHOD, AND COMPUTER PROGRAM

(71) Applicant: Sony Corporation, Tokyo (JP)

(72) Inventors: Satoshi Asai, Saitama (JP); Hisanori Nagata, Tokyo (JP)

(21) Appl. No.: 14/467,494

(22) Filed: Aug. 25, 2014

(30) Foreign Application Priority Data
Sep. 2, 2013 (JP) 2013-181474

(51) Int. Cl. H04N 21/431; H04N 21/422; H04N 21/482; H04N 21/81

(52) U.S. Cl. CPC H04N 21/4314; H04N 21/812; H04N 21/4222; H04N 21/4821; H04N 21/4823
USPC 725/42; 725/44

(57) ABSTRACT

Provided is an information display apparatus including an information acquisition section configured to acquire foreground information displayed on a foreground, a foreground screen generation section configured to generate a foreground screen based on the foreground information, a character string acquisition section configured to acquire character strings of one or more lines based on the foreground information, a background image generation section configured to generate a background image in which character strings acquired by the character string acquisition section are drawn, and an image combination section configured to superimpose the foreground screen on the background image, and generate a display screen.

### CROSS REFERENCE TO RELATED APPLICATIONS

This application claims the benefit of Japanese Priority Patent Application JP 2013-181474 filed Sep. 2, 2013, the entire contents of which are incorporated herein by reference.

### BACKGROUND

The technology disclosed in the present specification relates to an information display apparatus, an information display method, and a computer program which display detailed information on content such as a broadcast program or music content.

These days, information devices such as a personal computer, a smart phone, a tablet terminal and a digital book have become widely used. This kind of information devices can execute various application programs under execution environments provided by operating systems such as Windows (registered trademark), Android (registered trademark) and iOS. In addition, exchanging and sharing information can be performed via wireless networks such as Wi-Fi (registered trademark) (Wireless Fidelity) among users of each information device.

Many information devices are equipped with a touch panel. A user can start the same processing as a click on right and left buttons of a mouse by carrying out a tap or long press operation on a touch panel type screen. In addition, a screen can be made to slide by a swipe operation (sliding in a direction without scrolling) on the screen.

Using an information device, a user can view a broadcast or recorded program and also listen to music streamed from the internet or reproduced from a CD. For example, an EPG (Electric Program Guide) screen which has television programs from every broadcasting station displayed in a list in order of broadcasting time, and a play list showing available music content can be displayed on the information device, and when a user selects a desired content by carrying out a tap or the like, the screen can be switched to a content detail screen. The content detail screen displays detailed information on content such as a program title (including a subtitle), a broadcast date, a recording date in case of a recorded program, an upload date in case of program requested from a server, a performer and a program outline, or a title of a music piece, a songwriter, a composer, an arranger and lyrics. The user can also view a program or listen to music while on the content detail screen.

Recently, “smart televisions”, which have Internet technology and set top box functionality integrated into them, are being developed. For example, a multifunction terminal such as a smart phone or a tablet can configured to share and/or synchronize data with a television set, and a new service can be provided using multi-screens by setting the television screen as a main screen and the multifunction terminal as a second-screen (for example, refer to JP 2013-805020A). For example, it is possible to display the aforementioned content detail screen or program-related information or the like on the screen of a multifunctional terminal for a program being viewed or listened to on the television. It is also possible to control the television set from the multifunction terminal.

### SUMMARY

According to a technology disclosed in the present specification, it is desirable to provide an excellent information display apparatus, information display method and computer program which are capable of suitably displaying detailed information on content such as broadcast programs and music content.

The present application has been made in view of the above problems, and an embodiment of the present technology is an information display apparatus including an information acquisition section configured to acquire foreground information displayed on a foreground, a foreground screen generation section configured to generate a foreground screen based on the foreground information, a character string acquisition section configured to acquire character strings of one or more lines based on the foreground information, a background image generation section configured to generate a background image in which character strings acquired by the character string acquisition section are drawn, and an image combination section configured to superimpose the foreground screen on the background image, and generate a display screen.

According to another embodiment of the present technology, the information acquisition section of the information display apparatus according to an embodiment is further configured to acquire detailed information on predetermined content, and the foreground screen generation section is further configured to generate a content detail screen based on the detailed information on the predetermined content.

According to another embodiment of the present technology, the information acquisition section of the information display apparatus according to an embodiment is further configured to acquire detailed information on predetermined content, and the character string acquisition section is further configured to acquire predetermined character strings of one or more lines from among the detailed information on the predetermined content.

According to another embodiment of the present technology, the information acquisition section of the information display apparatus according to an embodiment is further configured to acquire detailed information on content related to a program as the foreground information, and the character string acquisition section is further configured to acquire a character string of a line corresponding to a main title of the program, a subtitle (provided that a subtitle is present), or a date from the detailed information on content related to the program.

According to another embodiment of the present technology, the information display apparatus according to an embodiment further includes an operation information acquisition section configured to acquire information related to a user's sliding operation on the foreground screen. The background image generation section is further configured to generate a background image to scroll in accordance with sliding of the foreground screen.

According to another embodiment of the present technology, the background image generation section of the information display apparatus according to an embodiment is further to configured to determine at least a character size, length, or display position of the character strings displayed on the background image.

According to another embodiment of the present technology, the background image generation section of the information display apparatus according to an embodiment is further configured to determine at least a character size or length of each line by multiplying a height and width of an effective display area of the foreground screen by respective predetermined ratios.

According to another embodiment of the present technology, the background image generation section of the information display apparatus according to an embodiment is further configured to cut only excessive number of characters from a character string of length exceeding the determined length of each line.

According to another embodiment of the present technology, the background image generation section of the information display apparatus according to an embodiment is further configured to determine an initial drawing position of a background image for every line, which has respective predetermined ratios with respect to a height and width of an effective display area of the foreground screen.

According to another embodiment of the present technology, the information display apparatus according to an embodiment further includes an operation information acquisition section further configured to acquire information related to a user's sliding operation on the foreground screen. the background image generation section is further configured to draw a background image for every line in each initial drawing position in a foreground screen slid to the leftmost end, and carry out drawing so that a right end of a background image of each line is in line with a right end of an effective display area of a foreground screen in a foreground screen slid to the rightmost end.

According to another embodiment of the present technology, the background image generation section of the information display apparatus according to an embodiment is further configured to determine a drawing position of a background image for every line in each slide position of a foreground image in accordance with a number of steps with which the foreground image slides in a right and left direction.

According to another embodiment of the present technology, the background image generation section of the information display apparatus according to an embodiment is further configured to determine a character color of a character string displayed on a background image based on color information which the foreground image has.

According to another embodiment of the present technology, the foreground information includes image information. The background image generation section of the information display apparatus is further configured to determine the character color based on a representative color of the image information.

According to another embodiment of the present technology, the background image generation section of the information display apparatus according to an embodiment is further configured to process the character color based on at least one of a luminance and chroma of the representative color.

According to another embodiment of the present technology, the information acquisition section of the information display apparatus according to an embodiment is further configured to acquire detailed information of broadcast content from data broadcast.

According to another embodiment of the present technology, the information acquisition section of the information display apparatus according to an embodiment is further configured to acquire detailed information of commercial content from a storage medium.

According to another embodiment of the present technology, the character string acquisition section of the information display apparatus according to an embodiment is further configured to acquire a character string associated with the foreground information from the Internet.

According to another embodiment of the present technology, the information display apparatus according to an embodiment further includes a display section configured to display a display screen where the background image is combined by the image combination section.

According to another embodiment of the present technology, there is provided an information display method including acquiring foreground information displayed on a foreground, generating a foreground screen based on the foreground information, acquiring character strings of one or more lines based on the foreground information, generating a background image in which character strings acquired by the character string acquisition section is drawn, and generating a display screen by superimposing the foreground screen on the background image.

According to another embodiment of the present technology, there is provided a computer program written in a computer readable format so as to make a computer function as an information acquisition section configured to acquire foreground information displayed on a foreground, a foreground screen generation section configured to generate a foreground screen based on the foreground information, a character string acquisition section configured to acquire character strings of one or more lines based on the foreground information, a background image generation section configured to generate a background image in which a character string for every line acquired by the character string acquisition section is drawn; and an image combination section configured to generate a display screen by superimposing the foreground screen on the background image.

A computer program according to an embodiment of the present disclosure is such that a computer program written in a computer-readable format is defined so as to implement predetermined processing on a computer. In other words, by installing the computer program according to the embodiment of the present disclosure into the computer, coordinated operation is exhibited on the computer, and operational effect identical to that of the information display apparatus according to the embodiment of the present disclosure can be obtained.

According to technologies disclosed in the present specification, it is possible to provide an excellent information display apparatus, information display method and computer program which are capable of suitably displaying detailed information on content such as broadcast programs and music content.

The information display apparatus to which technologies disclosed in the present specification are applied generates a background image using character strings of principal information among the detailed information on content (for example, a main title, subtitle and broadcast date or the like of the program in the case of broadcast content), and carries out displaying with the content detail screen superimposed in front of the background image, and therefore, there is an effect that it becomes easy for a user to view the principal information related to the content. In addition, even when the content detail screen slides or scrolls by a swipe operation or the like, character strings of the principal information among them continue to be displayed as the background image, and therefore, it is easy for a user to view or listen to the content all the time. In addition, by graphically displaying character strings constituting the detailed information on content as the background image, aesthetic appearance of the content detail screen can be enhanced.

Note that, an effect described in the present specification is merely an exemplification, and the effect of the present disclosure is not limited to this. In addition, the present disclosure may exert an additional effect further other than the above-mentioned effect.

Additional effects, characteristics and advantages of technologies disclosed in the present specification will become clear by more detailed description based on embodiments and drawings mentioned later.

### BRIEF DESCRIPTION OF THE DRAWINGS

FIG. 1 illustrates schematically a configuration example of a television system 100 to which a technology disclosed in the present specification is applied;

FIG. 2 is a figure illustrating schematically an internal configuration of an information terminal 200;

FIG. 3 is a transition diagram of a screen displayed on a display panel 221 when the information terminal 200 executes a television coordination application;

FIG. 4 illustrates a configuration example of a television program table screen 31;

FIG. 5 illustrates a configuration example of a Watch Now screen 32;

FIG. 6 illustrates a configuration example of an SNS screen 33;

FIG. 7 illustrates a configuration example of a CSS screen 34;

FIG. 8 illustrates a configuration example of a content detail screen (Information) 35;

FIG. 9 illustrates a configuration example of an SNS list screen (SNS) 36;

FIG. 10 illustrates a configuration example of a related program list screen (Related) 37;

FIG. 11 is a figure for describing a scheme to generate a background image where a specific character string included in the detailed information on content is displayed graphically;

FIG. 12 is a figure for describing a scheme to generate a background image where a specific character string included in detailed information on content is displayed graphically;

FIG. 13 is a figure for describing a scheme to generate a background image where a specific character string included in detailed information on content is displayed graphically;

FIG. 14 illustrates schematically a functional configuration example for generating a content detail screen 35 having the background image;

FIG. 15 is a flow chart illustrating a processing procedure for determining a character size, size (length) and display position of the character string displayed as the background image;

FIG. 16A is a flow chart illustrating a processing procedure for determining a character color of the character string displayed as the background image; and

FIG. 16B is a flow chart illustrating a processing procedure for determining a character color of the character string displayed as the background image.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

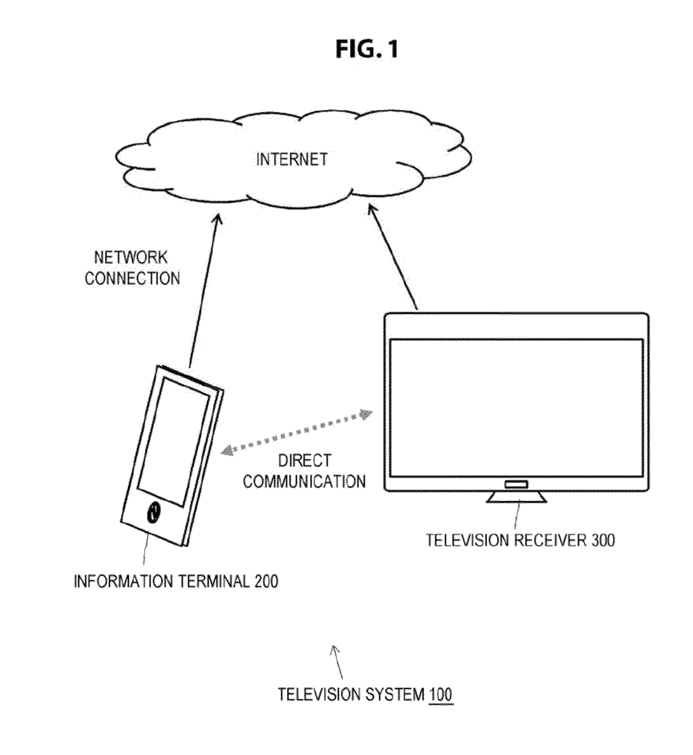

In FIG. 1, a configuration example of a television system 100 to which the technology disclosed in the present specification is applied is illustrated schematically. The illustrated television system 100 includes an information terminal 200 which a user possesses and a main body of a television receiver 300.

The information terminal 200 and the television receiver 300 are coordinated with each other directly via a wireless network such as Wi-Fi, or through a wide area network such as the Internet, and information is synchronized constantly or periodically. In addition, the information terminal 200 and the television receiver 300, while being coordinated with each other, constitute a multi-screen where a screen of the television receiver 300 is used as a main screen, and a touch screen of the information terminal 200 is used as a sub-screen.

The information terminal 200 is a touch-panel type of multifunctional portable terminal such as a smart phone or a tablet, and can execute various application programs under execution environments provided by an operating system such as Android (registered trademark) and iOS. For example, charged or free of charge Android (registered trademark) applications can be downloaded (well-known) to the information terminal 200 from an applications market such as Google Play.

For example, by installing a television coordination application such as “TV SideView”, the information terminal 200 can function as a television program table having a remote control function. Specifically, the following services (1) to (5) will be available on a second-screen of the information terminal 200.

(1) Program searching on a television program table displayed by an application at hand, and channel switching on the television receiver 300 side; (2) Remote control operation of the television receiver 300 by tapping on the touch panel; (3) Searching information content associated with a television program being viewed or listened; (4) Browsing of detailed information on content such as a television program being viewed or listened; and (5) Writing comments on a television program being viewed or listened to a social network service (SNS) and sending messages thereto.

Note that, it is also possible as a matter of course that services (1) to (5) using the second-screen on the above information terminal 200 side are utilized on the main screen of the television receiver 300 without using the information terminal 200 by screen switching between screen images of the services and the main program.

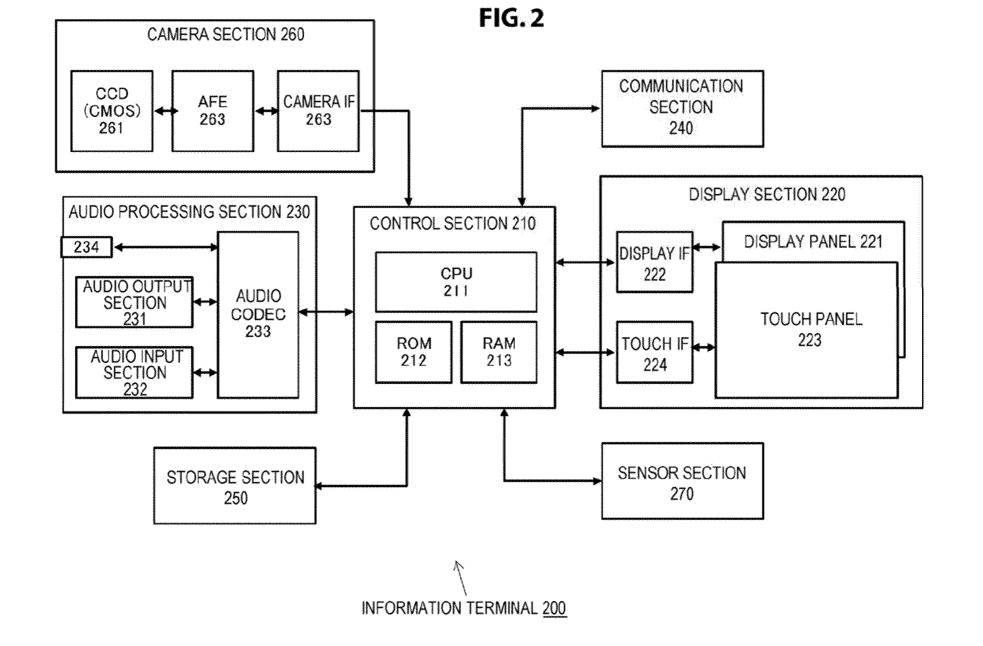

In FIG. 2, an internal configuration of the information terminal 200 is illustrated schematically. The information terminal 200 as illustrated is configured by a display section 220, an audio processing section 230, a communication section 240, a storage section 250, a camera section 260, a sensor section 270 and the like, all of which are connected to a control section 210.

The control section 210 is made up of a CPU (Central Processing Unit) 211, a ROM (Read Only Memory) 212 and a RAM (Random Access Memory) 213 and the like. In the ROM 212, a program code which the CPU 211 executes and information indispensable to the information terminal 200 and the like are stored.

The CPU 211 loads a program code from the ROM 212 or the storage section 240 to the RAM 213 and executes the program code. The programs which the CPU 211 executes may include an operating system such as Android or iOS, and various application programs such as television coordination applications which operate under execution environments provided by the operating system.

The display section 220 includes a display panel 221 which is made up of a liquid crystal element or an organic EL (Electro Luminescence) element or the like, and a transparent touch panel 223 stuck on the upper surface of this display panel 221. The display panel 221 is connected to the control section 210 via a display interface 222, and displays and outputs image information generated in the control section 210. In addition, the touch panel 223 is connected to the control section 210 via a touch interface 224, and outputs, to the control section 210, coordinates information operated by a user using a fingertip on the display panel 221. On the control section 210 side, a user's operation such as tap, long press, flick or swipe is detected based on the input coordinates information, and processing corresponding to the user's operation is started.

The audio processing section 230 includes an audio output section 231 such as a loudspeaker, an audio input section 232 such as a microphone and an audio codec (CODEC) 233 which carries out encoding/decoding processing of an output/input audio signal. In addition, the audio processing section 230 may further include an output terminal 234 for outputting the audio signal to a headphone (not shown).

The communication section 240 performs information communication processing between applications executed in the control section 210 and an external device. External devices mentioned here may include the television receiver 300, an information terminal (not shown) handled by other users and a server which exists on the Internet and the like. The communication section 230, while equipped with physical layer modules for Wi-Fi, NFC (Near Field Communication), Bluetooth (registered trademark) or the like in accordance with communication media to be used, performs modulation/demodulation processing and encoding/decoding processing of communication signals transmitted/received via the physical layer module. In addition, a download of an application such as a television coordination application, and information such as an EPG screen and detailed information on content which are displayed on the display section 220 are acquired via the communication section 240.

The storage section 250 is made up of a large-capacity storage device such as an SSD (Solid State Drive) or an HDD (Hard Disc Drive). For example, an application program and content which are downloaded via the communication section 240 and image data such as a still picture and motion picture which are photographed by the camera section 260 and the like are stored in the storage section 250.

The camera section 260 includes an image sensor 261 such as a CCD (Charge Coupled Device) or a CMOS (Complementary Metal Oxide Semiconductor) which carries out photoelectric conversion of light taken in via a lens (not shown), and an AFE (Analog Front End) processing section 262 which generates image data by performing noise removal and digitization of the detection signal in the image sensor 261, and outputs the generated image data to the control section 210 from a camera interface 263.

The sensor section 270 includes a GPS (Global Positioning System) sensor for acquiring positional information of the information terminal 200, a gyro sensor and an acceleration sensor and the like for detecting an attitude of the information terminal 200 main body and a force that acts thereon.

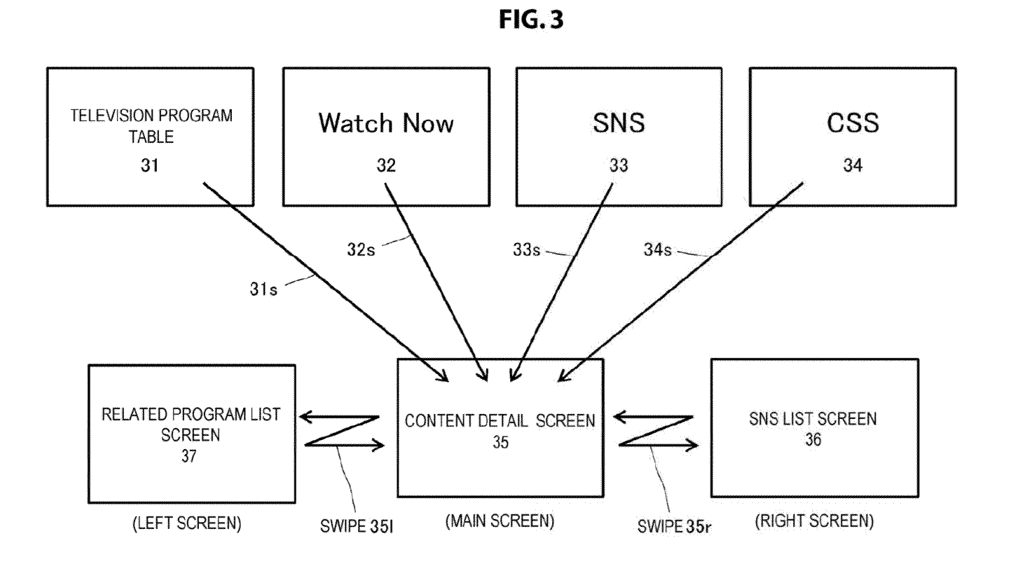

In FIG. 3, a transition diagram of a screen displayed on the display panel 221 when the information terminal 200 executes a television coordination application is illustrated. In FIG. 3, reference numerals 31, 32, 33 and 34 are a television program table screen, a Watch Now screen, an SNS screen and a CSS screen, respectively. A user, when finding out content such as a desired (or favorite) program in each of the screens 31 to 34, carries out a tap operation or the like on the position, and selects the content. Then, as illustrated with reference numerals 31s, 32s, 33s and 34s, the screen transitions to a content detail screen 35 which displays detailed information of the selected content.

On the content detail screen (main screen) 35, a user can perform a swipe (that is, slide of a screen in a horizontal or vertical direction without scrolling) operation. When a swipe operation is carried out rightward once as indicated with a reference numeral 35r, the screen slides to another content detail screen (right screen). In the illustrated example, the right screen is an SNS list screen 36 which carries out list display of SNS (Comment contribution site or the like) of each performer of this program content.

In addition, on the content detail screen 35, when a swipe operation is carried out leftward once as indicated with a reference numeral 351, the screen slides further to an another content detail screen (left screen). In the illustrated example, the left screen is a related program list screen 37 which displays a list of other program content associated with this program.

Note that, in FIG. 3, although an example where a screen slides in a right or left direction with three steps on the content detail screen 35 is illustrated, it is also possible to configure transition of the content detail screen so that the screen may slide in a right or left direction with four or more steps.

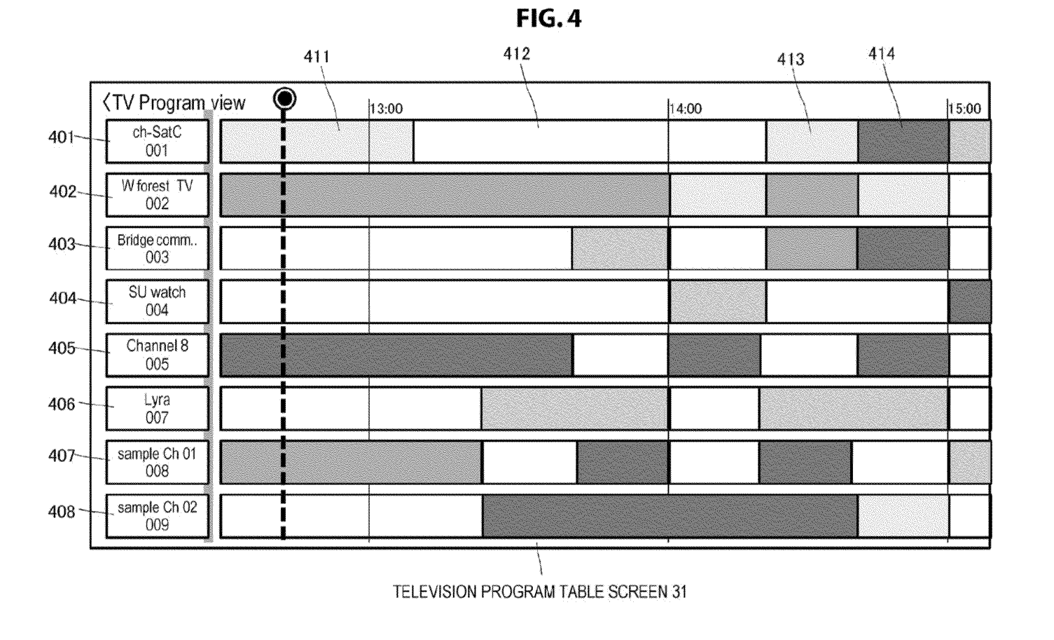

In FIG. 4, a configuration example of a television program table (TV Program view) screen 31 is illustrated. The television program table screen 31 is made up of a list of broadcast channels in order of channel numbers. In the illustrated example, each of broadcast channels 401, 402, 403 etc. is laid out in order of the channel numbers in a vertical (vertical axis) direction. In addition, the horizontal (horizontal axis) direction of the television program table screen 31 corresponds to a time axis. Each row corresponds to a broadcast channel, and within each row there are blocks corresponding to the programs arranged along the time axis. Each program block 411, 412 etc. has a horizontal position and length corresponding to a broadcast time zone. In each program block, principal or important information, such as a main title, subtitle (provided that a subtitle is present) and performer name of the program, is displayed in as many characters as can be fitted in each program block (illustration is omitted in FIG. 4). The information, such as a title, subtitle and performer name, which is displayed within each program block can be acquired from EPG information distributed along with the broadcast content. The title displayed within each program block may serve as a link by clicking which a user may transition to the detailed screen of the respective program from the television program table screen.

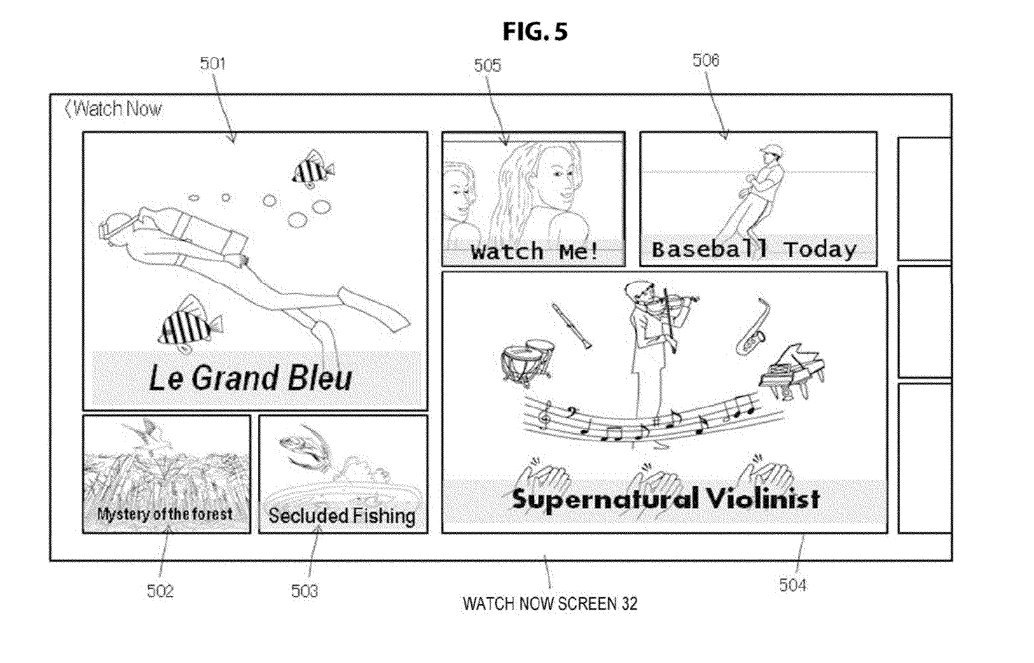

In FIG. 5, a configuration example of the Watch Now screen 32 is illustrated. The Watch Now is an application corresponding to a part of the “TV SideView” application, and provides an interactive and visual program guide based on user's personal preference and trend information shown by social media. The Watch Now screen 32 illustrated in FIG. 5 is configured by laying out two or more of representative pictures 501, 502 etc. of the program content which are extracted based on user's personal preference and trend information shown by social media. Each of representative pictures 501, 502 etc. has a program name displayed on the lower side of the frame, and each picture acts as a link which can be used to transition to a detailed screen of the respective program. A user can make the screen transition to the detailed screen of a program by tapping the corresponding representative picture.

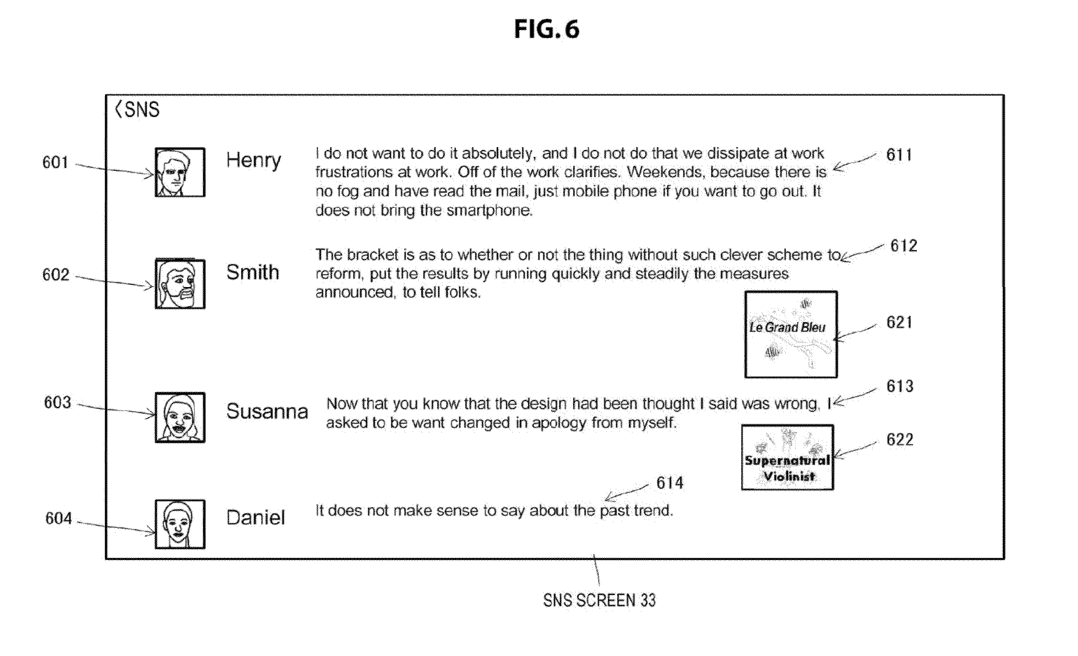

In FIG. 6, a configuration example of the SNS screen 33 is illustrated. The SNS screen 33 is made up of a list of comments 611, 612 etc., which are related to a program, and were posted on some social media platform by some users 601, 602 etc., who may be chosen arbitrarily or based on some pre-defined criteria. To the right of at least some of said comments a thumbnail of the representative picture 621, 622 etc. of the corresponding program is attached. The thumbnail acts as a link which can be used to transition to the detailed screen of the corresponding program. A user can make the screen transition to the detailed screen of a program by tapping the corresponding thumbnail.

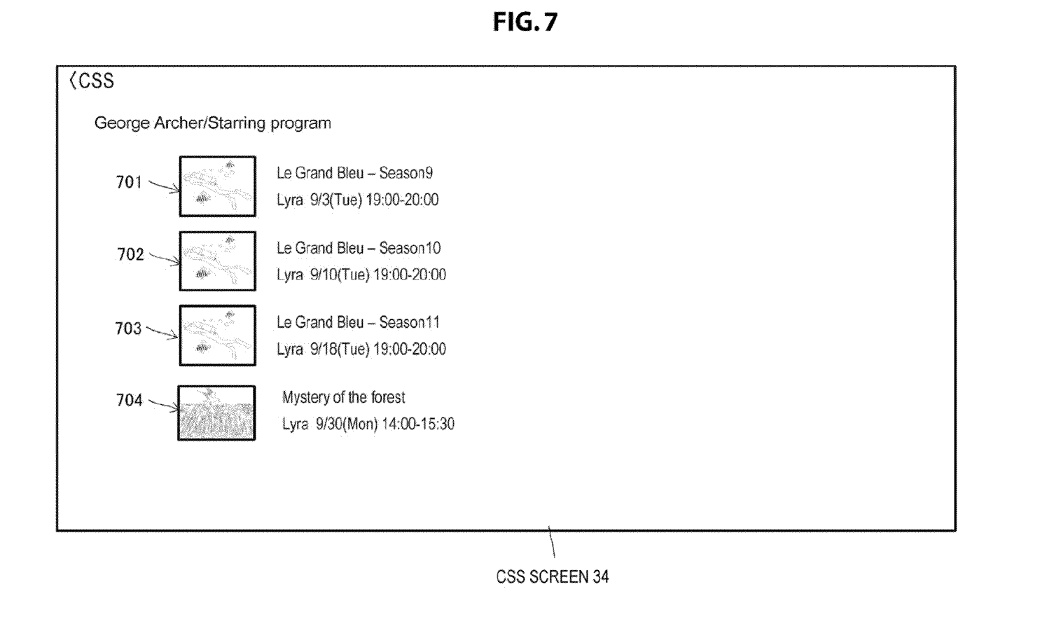

In FIG. 7, a configuration example of the CSS screen 34 is illustrated. The CSS screen 34 is Cross Service Search, i.e., a search result screen across services. The example illustrated in FIG. 7 is the search result screen acquired by searching for a performer name, and is made up of a list of programs 701, 702 etc. in which the performer has performed. A thumbnail of a representative picture of each of the programs is displayed together with a main title, subtitle (provided that a subtitle is present), and broadcast/release/recording date and the like of the program. The thumbnails act as anchor links which can be used to transition to a detailed screen of the corresponding program, and a user can make the screen transition to the detailed screen by tapping the desired thumbnail.

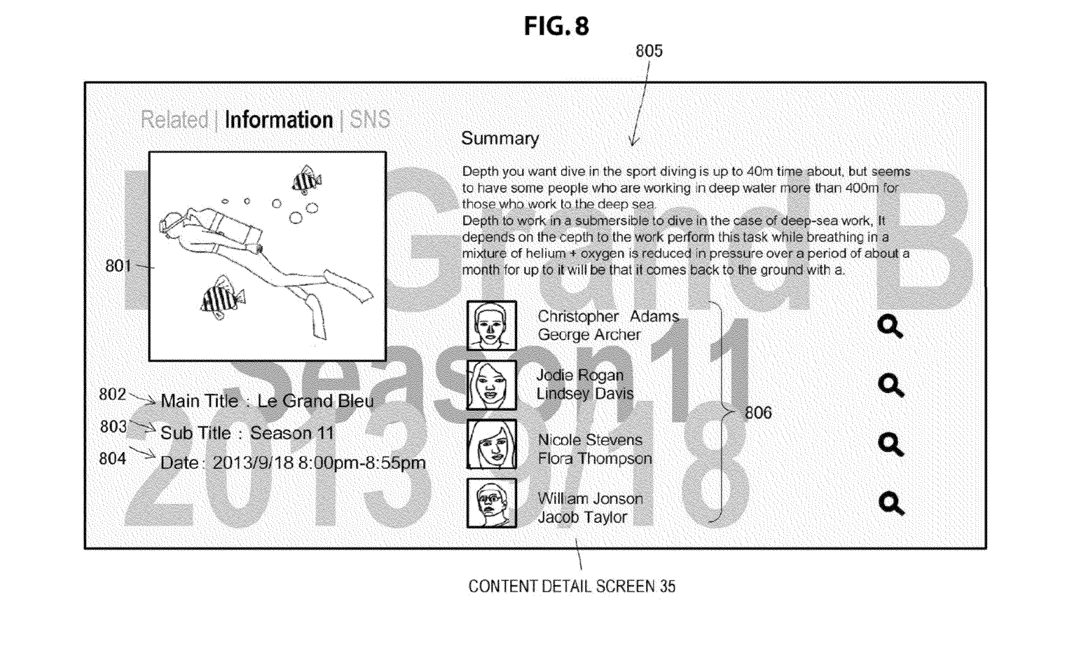

In FIG. 8, a configuration example of the content detail screen (Information) 35 is illustrated. From the screens displayed in FIGS. 4 to 7, the information terminal 200 is switched over to the content detail screen 35 of the corresponding program by a selection operation such as tapping of the desired anchor link by a user. The content detail screen 35 corresponds to the main screen containing detailed information on the program, and includes a thumbnail 801 which is a representative picture of this program, principal information such as the main title 802, subtitle (provided that a subtitle is present) 803 and broadcast/release/recording date 804 of the program, an outline (Summary) 805 of this program, and a list 806 of program performers.

In the case of the broadcast content, the detailed information on content can be acquired from data broadcast transmitted along with the program broadcast, for example. In addition, in the case of commercial content such as a DVD and a Blue-ray, detailed information on the content can be acquired by using a CDS (Content Directory Service) which hierarchizes and distributes a list of contents and relevant detailed information formulated in UPnP (Universal Plug and Play), which forms the basis of DLNA (Digital Living Network Alliance). Alternatively, apart from these schemes, the detailed information on content may be provided by a service using a cloud technology.

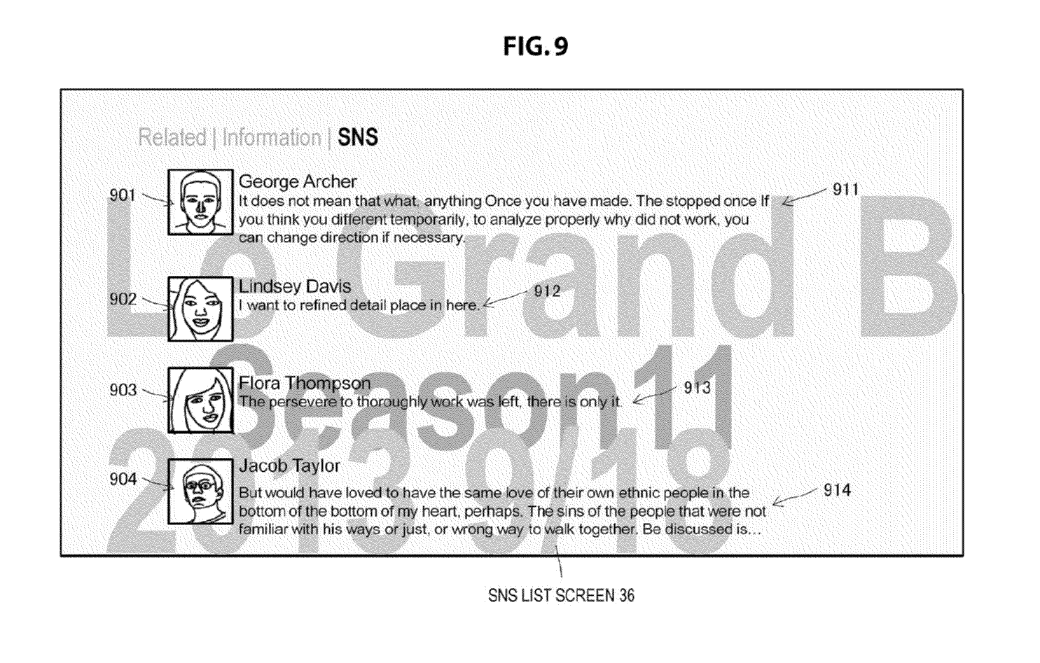

In FIG. 9, a configuration example of the SNS list screen (SNS) 36 is illustrated. When a user carries out a swipe operation once rightward on the content detail screen 35 illustrated in FIG. 8, the display of the screen slides rightward, and transitions to the SNS list screen 36 illustrated in FIG. 9. The SNS list screen 36 is made up of a list of SNS information of each performer of this program. The SNS information includes thumbnails 901, 902 etc. such as a facial portrait of each performer, name of the performer, and the newest comment (where the length of character strings does not exceed a predetermined number) 911, 912 etc. In addition, when a user carries out a swipe operation once leftward on this SNS list screen 36, the display of the screen slides leftward, and returns to the content detail screen 35.

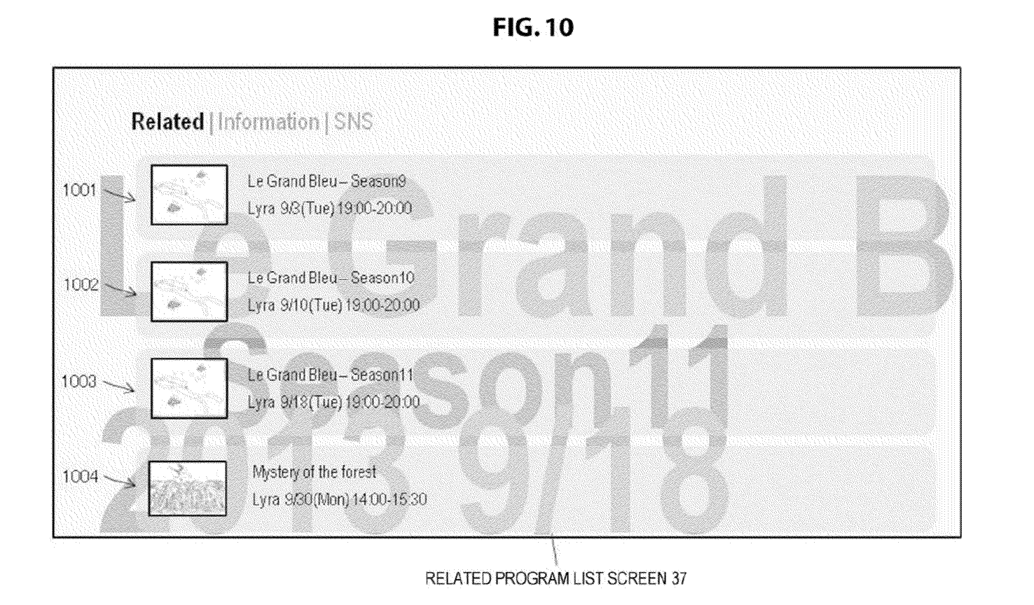

In addition, In FIG. 10, a configuration example of the related program list screen (Related) 37 is illustrated. When a user carries out a swipe operation once leftward on the content detail screen 35 illustrated in FIG. 8, the display of the screen slides leftward, and transitions to the related program list screen 37 illustrated in FIG. 10. The related program list screen 37 is made up of a list of program information of programs associated with this program. A selection method of a related program mentioned here is optional. The selection basis used to select a related program may include, but is not limited to, a successive series program, a program in which at least one keyword is the same or similar, and a program in which at least one performer is the same, or the like. In columns 1001, 1002 etc. of each program information, a thumbnail of a representative picture of the program is displayed together with principal information such as the main title, subtitle (provided that a subtitle is present) and broadcast/release/recording date of the program. The thumbnail acts as an anchor link which may be used to transition to the detailed screen of the corresponding program, and a user can make the screen transition to the detailed screen of a program by tapping the corresponding thumbnail. In addition, when a user carries out a swipe operation once rightward on this related program list screen 37, the display of the screen slides rightward, and returns to the content detail screen 35.

In FIG. 3, although an example where the screen of the content detail screen 35 slides with three steps of the right screen, main screen and left screen has been illustrated, it is also possible to configure the screen transition in a right or left direction so that the screen may slide with two or fewer steps, or four or more steps. Hereinafter, for convenience, screen sliding with three steps only will be explained.

In the content detail screens 35 to 37 illustrated in FIGS. 8 to 10, gray character strings drawn on the sheet surface with a graphical font in the background of each of display components 801, 802 etc. and 901, 902 etc. and 1001, 1002 etc. are background images. In the present embodiment, the background images are generated in which several lines of character strings, which are principal among the detailed information on content displayed on the content detail screen of the main picture, are graphically displayed with a predetermined character size using a predetermined font. The principal detailed information on content mentioned here may be information which is indispensable for viewing, listening and recording reservation of the program such as the main title “Le Grand Bleu”, subtitle “Season 11” (provided that a subtitle is present) and broadcast/release date “2013 Sep. 18” of the program.

In the content detail screen 35 illustrated in FIG. 8, the principal information such as the main title, subtitle and broadcast date of the program are indicated also as a foreground of the screen as displayed with reference numerals 802 to 804. By displaying graphically the three lines of character strings made up of the main title, subtitle and broadcast date of the program as the background image, the information is emphasized further, and a user can easily know when the user can view and/or listen to the content.

In addition, when a user carries out a swipe operation in a right or left direction on the content detail screen 35, the screen transitions (refer to FIG. 3) to the SNS list screen 36 (refer to FIG. 9) or the related program list screen 37 (refer to FIG. 10) respectively, each of which is another configuration of the content detail screen. In both the SNS list screen 36 and the related program list screen 37, the main title, the subtitle, and the broadcast date are not displayed in the foreground of the screen of the program any longer. However, since the three lines of character strings of the main title “Le Grand Bleu”, subtitle “Season 11”, and broadcast date “2013 Sep. 18” of the program continue to be displayed as the background image in the screens 36 and 37, it is easy for a user to remember when the user can view and/or listen to the content while on the screens 36 and 37. Note that, although illustration is omitted, the three lines of character strings of the main title, subtitle, and broadcast date of the program continue to be displayed as the background image while the screen is being scrolled but hasn't completed scrolling to another screen This provides a smooth transition to the next screen and a seamless continuity to the user interface.

In FIGS. 8 to 10, the background image, as an example, consists of three lines of character strings, namely the main title, subtitle and broadcast date of the program. Graphical effect can be enhanced by changing a font, a character size, a display position and a size (length) of a display area of each line (in other words, of each kind of information to be displayed). Such graphical effects can further draw a user's attention to the character string displayed as the background image. As a matter of course, the background image may be generated while character strings in all lines are displayed uniformly with the same font and the same character size.

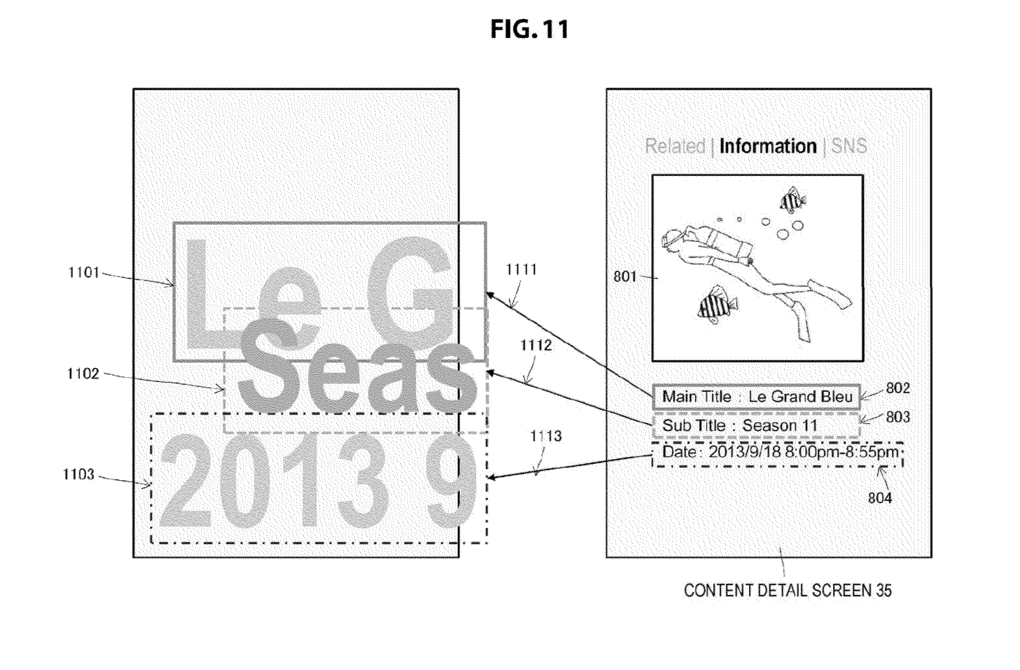

In FIGS. 11 to 13, a scheme to generate a background image where a specific character string included in the detailed information on content is displayed graphically is diagrammed. By displaying the character strings such that character size, display position, and size (length) of the display area is different for each line, the background image can be made more graphical. Here, for convenience, the character strings are assumed to be displayed using the same font in all the lines. In addition, due to space considerations, each figure is drawn longitudinally in the background of the content detail screen. In the case of a broadcast content, it is assumed that three lines of character strings comprising a main title, subtitle (provided that subtitle is present), and broadcast date of the program are extracted from the detailed information on the program, and the three lines of character strings are displayed in a graphically-appealing manner as the background image.

In FIG. 11, a state where character strings used for the background image are extracted from the content detail screen (Information) 35 is illustrated. Three lines of character strings comprising the main title 802, subtitle 803 and broadcast date 804 of the program are extracted from the content detail screen 35 illustrated in the right hand side of FIG. 11 as indicated with reference numerals 1111, 1112, and 1113. Then, as illustrated in the left hand side in FIG. 11, the character strings in each line are assigned as background images 1101, 1102 and 1103, respectively.

The character strings used in the background image can be acquired from the EPG information distributed along with the broadcast content. However, acquisition method of the character strings used in the background image is not limited to this. For example, character strings to be used for the background image may be distributed within data broadcast content associated with the program content (apart from EPG information).

In addition, character strings displayed in the background image are not limited to three kinds or three lines of the main title, subtitle and broadcast date of the program. For example, using natural language processing to carry out semantic analysis and context analysis and the like of the outline (Summary) included in detailed information of the program, one or more phrases and keywords may be extracted automatically to form a predetermined number of lines of character strings to be displayed in the background image. Alternatively, by performing processing such as text mining or information filtering, comments on the program, which are written on various kinds of contribution sites, may be extracted automatically as character strings and from among said character strings one or more phrases or keywords may be displayed in the background image. When the arithmetic load of the aforementioned processing is heavy for a single information terminal 200, a character-string-extraction service using a cloud technology may be provided.

In addition, the number of lines of character strings displayed in the background image is not limited in particular. Hereinafter, for convenience, an embodiment, in which three lines of character strings comprising the main title, subtitle and broadcast date of the program are displayed in the background image, will be described mainly. In addition, extraction method of character strings to be displayed as the background image is assumed to be optional.

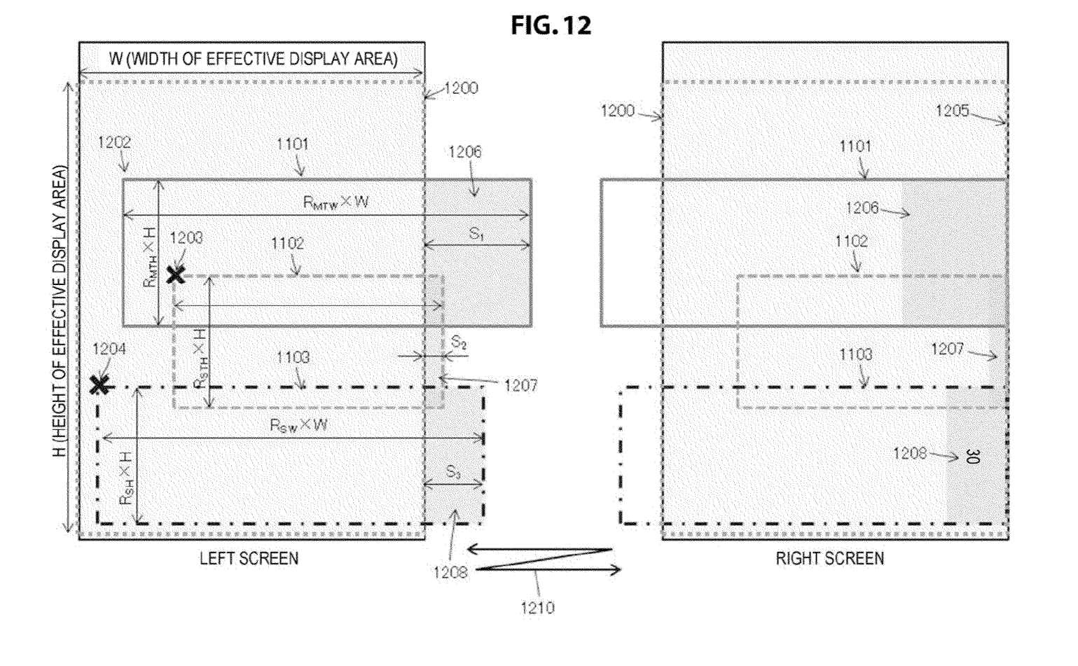

In FIG. 12, a scheme to determine a character size, size (length) and display position of the character string in each line which is displayed in the background image is diagrammed. The display position, character size and size (length) of each of the background images 1101, 1102 and 1103 are determined based on a size of an effective display area 1200. The effective display area 1200 is an area surrounded by a dotted line, where the background image can be arranged, and hereinafter, it is assumed that a height is H and a width is W.

Character sizes in the background images 1101, 1102 and 1103 are made to be values R_{MTH}×H, R_{STH}×H and R_{SH}×H where the height H of the effective display area 1200 is multiplied by constant ratios R_{MTH}, R_{STH} and R_{SH} which are configured for background images 1101, 1102 and 1103, respectively. When only one line of a character string is displayed in each of background images 1101, 1102 and 1103, character sizes R_{MTH}×H, R_{STH}×H and R_{SH}×H will correspond to heights of the background images 1101, 1102 and 1103, respectively. Each of ratios R_{MTH}, R_{STH} and R_{SH} is configured in view of the importance of character strings displayed in the background images 1101, 1102 and 1103, for example. When the main title of the program is displayed in the background image 1101 and the subtitle is displayed in the background image 1102, configuring thereof may be carried out so as to be R_{MTH}>R_{STH} since the main title is more important.

In addition, lengths of the background images 1101, 1102 and 1103 are made to be values R_{MTW}×W, R_{STW}×W and R_{SW}×W where the height W of the effective display area 1200 is multiplied by constant ratios R_{MTW}, R_{STW} and R_{SW} which are configured for each of the background images 1101, 1102 and 1103, respectively. Each of the ratios R_{MTW}, R_{STW} and R_{SW} is configured in view of the importance of character strings displayed in the background images 1101, 1102 and 1103, for example. When the main title of the program is displayed in the background image 1101 and the subtitle is displayed in the background area 1102, configuring thereof may be carried out so as to be R_{MTW}>R_{STW} since the main title is more important.

Character sizes in the background images 1101, 1102 and 1103 are determined to be R_{MTH}×H, R_{STH}×H and R_{SH}×H based on the height H of the effective display area 1200, respectively. Therefore, by dividing lengths determined with respect to each of the background images 1101, 1102 and 1103 by the character size, the number of characters (maximum character string length) which each can display can be determined.

It is also considered that the character string to be displayed in each of the background images 1101, 1102 and 1103 exceeds the maximum character string length determined based on the width W of the effective display area 1200. In such a case, the original character string is cut in the middle so as to come within the maximum character string length. For example, when the main title of the program displayed in the background image 1101, while being a character string made up of 21 characters “A long, long time ago”, is determined to have the maximum character string length of fifteen characters, six characters “me ago” from the last which exceed fifteen characters within the character string of the main title may be cut as an excessive character string, and only the character string “A long and long ti” up to the 15th character from the head may be displayed as the background image 1101.

Note that, an alternative method where the excessive character string is cut not from the last of the original character string but from the head or the center is also considered. However, since it is concerned that the original character string is thought of from the remaining character string after the excessive character string is cut from the head or center, it is considered that cutting from the last is preferred. Like English or Japanese, in the case of a language written from the left toward the right, the excessive character string will be cut from the right end of the character string. On the other hand, in the case of a language written from the right toward the left like Arabian, the excessive character string may be cut from the left end of the character string.

In addition, it is preferred that a color in which the character string is drawn in the background images 1101, 1102 and 1103 (hereinafter, referred to as “character color”) is made not to be an obstacle of the content detail screen 35 which is the foreground, as the background to the last. For example, a color having a “representative color” extracted from the representative picture of the content displayed as the thumbnail 801 processed may be used as the character color. The intention to process the representative color is in avoiding the following situations where information on the screen displayed as the foreground becomes difficult to be seen when the character color of the background image is deep, and to the contrary, the character string of the background image becomes hard to be read when the character color is light.

Next, a method to determine the display position of the background image will be described. Initial drawing positions 1202, 1203 and 1204 of each of the background images 1101, 1102 and 1103, are configured in positions having offsets corresponding to a constant ratio with respect to the height H and width W of the effective display area 1200, respectively. However, the ratio mentioned here is assumed to have a different value in each of the background images 1101, 1102 and 1103 (in other words, for every line of the character string displayed as the background image). As illustrated in the left hand side in FIG. 12, when being made to slide to the related program list screen 37 which is a left screen, the background images 1101, 1102 and 1103 are displayed in the initial drawing positions 1202, 1203 and 1204, respectively. Note that, when the transition of the content detail screen is configured so that the screen may slide with four or more steps in a right and left direction, the background images 1101, 1102 and 1103 are displayed in the initial drawing positions 1202, 1203 and 1204, respectively, when the screen is made to slide to the leftmost end. Since there is no regularity with respect to the initial drawing positions 1202, 1203 and 1204 of the background images 1101, 1102 and 1103, respectively, a graphical effect of the background image in the left screen (or screen slid to the leftmost end) will be enhanced.

When lengths of the background images 1101, 1102 and 1103 are long compared with the width of the effective display area 1200, right-hand sides of the background images 1101, 1102 and 1103 do not come within the effective display area 1200 when being displayed in the initial drawing positions 1202, 1203 and 1204 as illustrated in the left hand side in FIG. 12, and the areas 1206, 1207 and 1208 where the character string is not able to be displayed in the left screen may arise, respectively.

In addition, interlocking with sliding in a right and left direction of the content detail screen of the foreground (left screen <=> main screen <=> right screen) 1210, the background images 1101, 1102 and 1103 scroll from the initial drawing positions 1202, 1203 and 1204, respectively. When being made to slide to the SNS list screen 36 which is the right screen, the background images 1101, 1102 and 1103 are made to scroll so that right ends of the background images 1101, 1102 and 1103 may be in-line at the right end edge 1205 of the effective display area 1200 as illustrated in the right hand side in FIG. 12, respectively. Note that, when the transition of the content detail screen is configured so that the screen may slide with four or more steps in a right and left direction, the right top end position of each of the background images 1101, 1102 and 1103 in the screen slid to the rightmost end is made to be in-line at the right end edge 1205 of the effective display area 1200. In this way, the areas 1206, 1207 and 1208 of each of the background images 1101, 1102 and 1103 which are not able to be displayed in the left screen (or screen slid to the leftmost end) can be displayed in the effective display area 1200 when slid to the right screen (or the rightmost end). That is, while the content detail screen which becomes the foreground slides in such a way as the left screen <=> the main screen <=> the right screen, all the area of background images 1101, 1102 and 1103 can be exposed.

Scroll amount with which each of the background images 1101, 1102 and 1103 scrolls while the content detail screen which will be the foreground slides from the right screen up to the left screen (or, from the screen of the leftmost end up to the screen of the rightmost end) are determined depending on each of the initial drawing positions 1202, 1203 and 1204 (offset from the left end of the effective display area in the initial drawing position) and the length. When the foreground is the left screen, areas 1206, 1207 and 1208 on the right-hand side of the background images 1101, 1102 and 1103 are not displayed, respectively (refer to the left hand side in FIG. 12), and however, when the foreground is the right screen, the right end of each of the background images 1101, 1102 and 1103 is arranged so as to be in-line at the right end edge 1205 of the effective display area 1200, and therefore, the areas 1206, 1207 and 1208 appear in the screen (refer to the right hand side in FIG. 12). In other words, it turns out that the widths of the areas 1206, 1207 and 1208 are scroll amounts S₁, S₂ and S₃ of the background images 1101, 1102 and 1103, respectively.

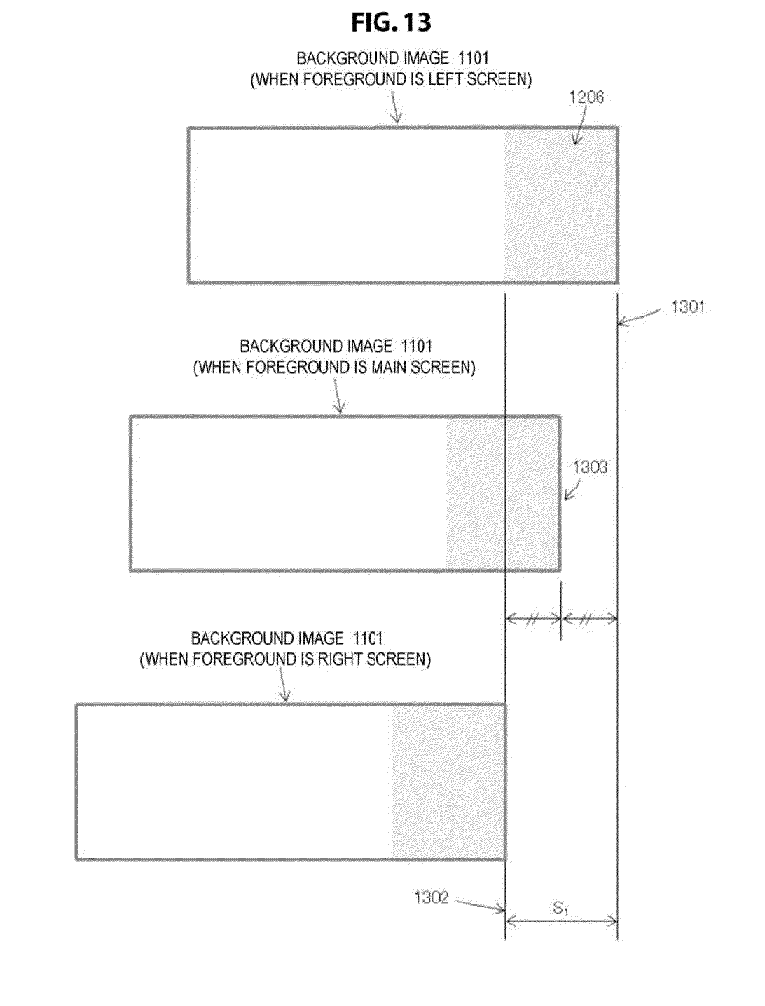

While the content detail screen which will be the foreground slides in such a way as the left screen <=> the main screen <=> the right screen, the background images 1101, 1102 and 1103 slide smoothly interlocking with that, and then, it is considered that the sliding is seen as natural by the user's eyes. An animation where the background image 1101 is made to scroll in connection with the sliding of the screen of the foreground will be described with reference to FIG. 13. In FIG. 13, a scroll position of the background image 1101 is illustrated by a relative position with respect to the screen of the foreground.

When the foreground is the left screen, the right end of the background image 1101 is located at a scroll position 1301 of the rightmost end which is deviated from the effective display area 1200. When the foreground is the right screen, the right end of the background image 1101 is located at a scroll position 1302 of the leftmost end which is in agreement with the right end of the effective display amount position 1200. A distance between these scroll positions 1301 and 1302 at both the right and left ends corresponds to the scroll amount S₁ of the background image 1101. When the screen slides with three steps of the left screen <=> the main screen <=> the right screen, if an animation of the background image 1101 at the time of the screen sliding is generated so that a position 1303 which divides between two points 1301 and 1302 into two equally may become a scroll position of the background image 1101 when the foreground slides to the central main screen, a natural motion of the animation will be realized.

Furthermore, in the case where the screen slides with N steps (where, N is assumed to be an integer no less than four), when the scroll position of the background image 1101 in each screen where the foreground is made to slide between the rightmost end and the leftmost end is determined by dividing the scroll amount S₁ by (N−1) (not shown), the animation of the background image 1101 at the time of the screen sliding becomes smooth in the same way. In addition, although illustration is omitted, the animation at the time of making the screen slide in a right and left direction is the same also with respect to other background images 1102 and 1103.

As illustrated in the right hand side in FIG. 12, right end positions of the background images 1101, 1102 and 1103 are in-line at a right end edge 1205 of the effective display area 1200. In addition, as illustrated in the left hand side in FIG. 12, the left end positions 1202, 1203 and 1204 of the background images 1101, 1102 and 1103 have been determined, respectively. Therefore, the animation of each of the background images 1101, 1102 and 1103 when the screen is made to slide in a right and left direction (that is, the left screen <=> the main screen <=> the right screen) will become almost the same without depending on the content (which will be an object whose detailed information is displayed).

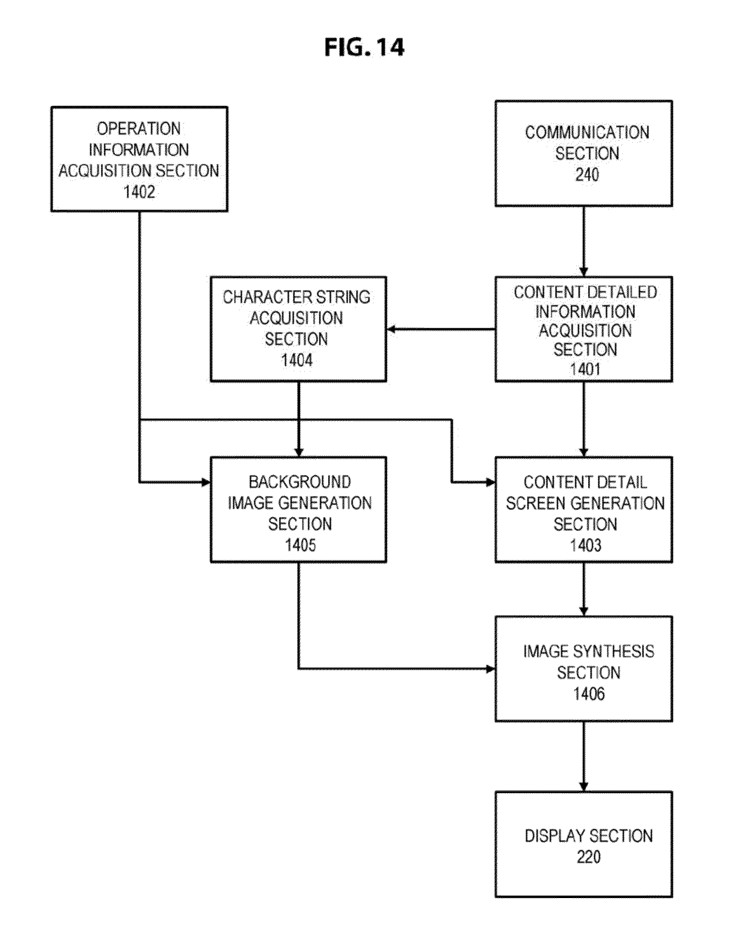

In FIG. 14, a functional configuration example for generating the content detail screen 35 with the background image is illustrated schematically. The illustrated example is configured so as to generate the content detail screen 35 with the background image while a content detailed information acquisition section 1401, an operation information acquisition section 1402, a content detail screen generation section 1403, a character string acquisition section 1404, a background image generation section 1405 and an image combination section 1406 operate cooperatively. Each of functional modules 1401 to 1406 can be realized by the configuration that a predetermined program code is executed in the control section 201. As a matter of course, it is also possible to implement a part or all of functional modules as dedicated hardware.

The content detailed information acquisition section 1401 acquires detailed information on content which is to be displayed on the content detail screen. For example, in accordance with a specific content having been selected on the television program table screen 31, the Watch Now screen 32, the SNS screen 33 and the CSS screen 34 and the like (refer to FIG. 3), the content detailed information acquisition section 1401 starts acquisition processing of the detailed information on content.

When the content is a broadcast program, the content detailed information acquisition section 1401 can acquire the detailed information on content from data broadcast transmitted along with the program broadcast. In addition, in the case of commercial content such as a DVD and a Blue-ray, the content detailed information acquisition section 1401 can acquire the detailed information on content using a CDS function. Alternatively, apart from these schemes, the content detailed information acquisition section 1401 may acquire the detailed information on content using a service provided by the cloud technology.

The operation information acquisition section 1402 inputs, via the touch interface 224, information of user operations such as tap, long press, flick and swipe which are performed by a user on the display panel 221 (or touch panel 223).

The content detail screen generation section 1403 generates the content detail screen in accordance with information of user operations from the detailed information on content acquired by the content detailed information acquisition section 1401. In addition, when a swipe operation in a right and left direction of the screen is performed, the content detail screen generation section 1403 generates the related program list screen as the left screen, and the SNS list screen as the right screen.

The character string acquisition section 1404 acquires character strings used as the background image of the content detail screen.

In the case of broadcast content, character strings displayed as the background image are three lines (or three kinds) of character strings of the main title, subtitle (provided that subtitle is present) and broadcast date of the program, for example. The character string acquisition section 1404 can acquire character strings of the predetermined number of lines displayed as the background image from the EPG information distributed along with the broadcast content. However, a method in which the character string acquisition section 1404 acquires main information is not limited in particular. For example, through natural language processing to carry out semantic analysis and context analysis and the like of the outline (Summary) of the program, one or more phrases and keywords included in the text may be extracted automatically as character strings to be displayed as the background image. Alternatively, comments on the program which are written in various kinds of contribution sites may be extracted automatically as character strings which display one or more phrases and keywords included in the text as the background image while processing such as text mining or information filtering or the like is applied. In addition, the character string acquisition section 1404 may acquire character strings of the predetermined number of lines displayed as the background image from a huge amount of text data using a service provided by the cloud technology.

The background image generation section 1405 generates the background image of the content detail screen using character strings of the predetermined number of lines acquired by the character string acquisition section 1404. As described already with reference to FIGS. 11 to 13, the background image generation section 1405 generates the background image where the character string in each line is displayed graphically. In the present embodiment, while the character size, size (length) of the display area and display position are made to differ in each line (or, in each kind of character string information), the background image is generated. In addition, the animation where the background image slides in synchronization with the content detail screen sliding to the left screen <=> the main screen <=> the right screen by the user's swipe operation or the like acquired by the operation information acquisition section 1402 is generated. In addition, the background image generation section 1405 determines a character color of character strings displayed as the background image based on the information on colors of the content detail screen. Details with respect to processing to determine a character color in the background image generation section 1405 will be described later.

The image combination section 1406 superimposes the content detail screen generated by the content detail screen generation section 1403 on the background image generated by the background image generation section 1405, and completes a display image, and then, outputs the display image to the display panel 221.

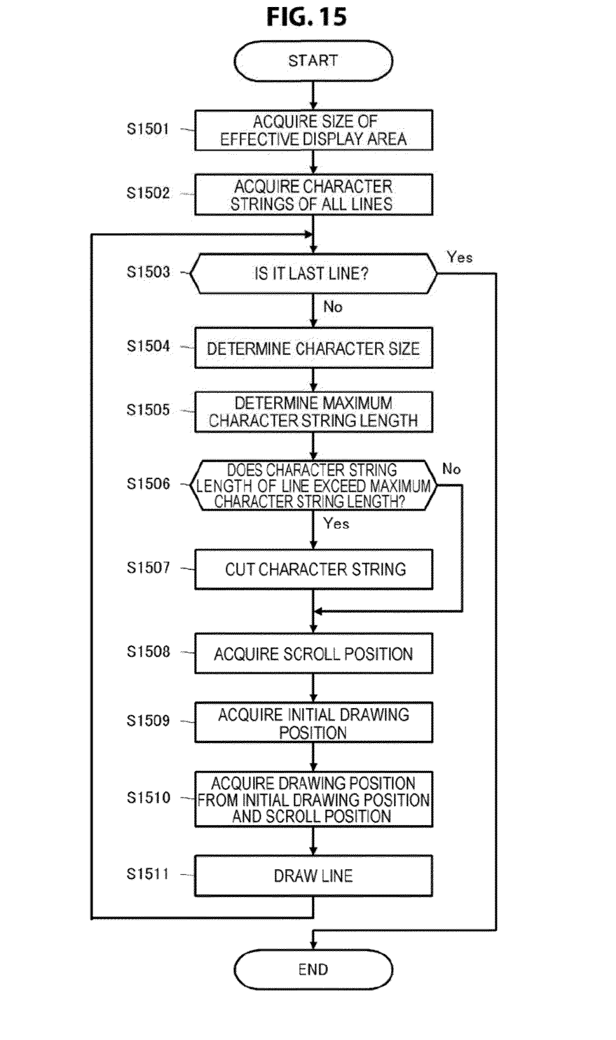

In FIG. 15, processing procedures for the background image generation section 1405 to determine a character size, a size (length) and a display position of the character string displayed as the background image are illustrated in a form of a flow chart.

The background image generation section 1405, first, acquires a size (height H and width W) of the effective display area where the background image can be displayed (Step S1501). The size of the effective display area is determined based on a screen size or the like of the display panel 221.

Then, the background image generation section 1405 acquires character strings of all the lines acquired by the character string acquisition section 1404 (Step S1502), and executes processing to draw the character string in the background image repeatedly with respect to each line (Step S1503 or subsequent ones).

The background image generation section 1405 determines the character size of character strings to be displayed as the background image based on the height H of the effective display area (Step S1504). Specifically, a value where the height H of the effective display area is multiplied by a ratio configured with respect to the background image is made to be the character size.

Next, the background image generation section 1405 determines a length of the background image, i.e., the maximum character string length of the character string to be displayed as the background image based on the width W of the effective display area and the character size determined in Step S1504 (Step S1505).

Then, the background image generation section 1405 checks whether a character string of the line which is currently under processing exceeds the maximum character string length determined in Step S1505 (Step S1506).

Here, when a character string under drawing processing exceeds the maximum character string length as the background image (Yes of Step S1506), the excessive character string is cut from the last of the character string, and the number of characters are reduced so as to come within in the background image (Step S1507).

Next, the background image generation section 1405 acquires a scroll position and initial drawing position of the background image under processing from the width W and height H of the effective display area, and the maximum character string length (Step S1508, S1509).

Next, the background image generation section 1405 calculates a drawing position of the background image corresponding to the current slide position of the content detail screen (Step S1510) based on the scroll position and the initial drawing position, and generates the background image where the character string with respect to the line is drawn in the drawing position (Step S1511), and then, returns to Step S1503.

Then, when drawing of the background image is completed with respect to all the acquired lines (Yes of Step S1503), the image combination section 1406 combines the content detail screen on the background image drawn by the background image generation section 1405, and completes a display image, and then, outputs the display image to the display panel 221.

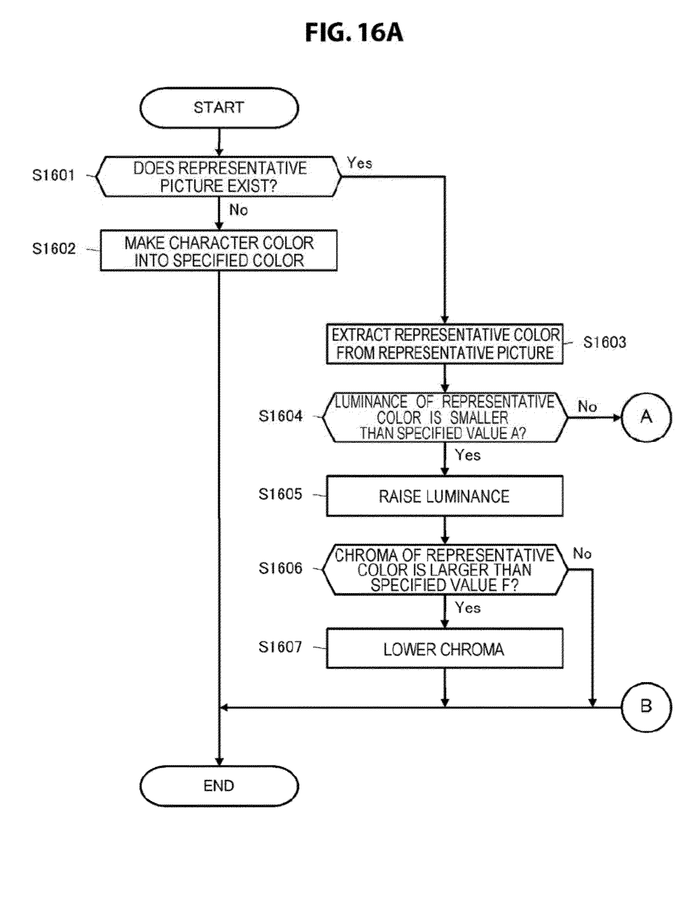

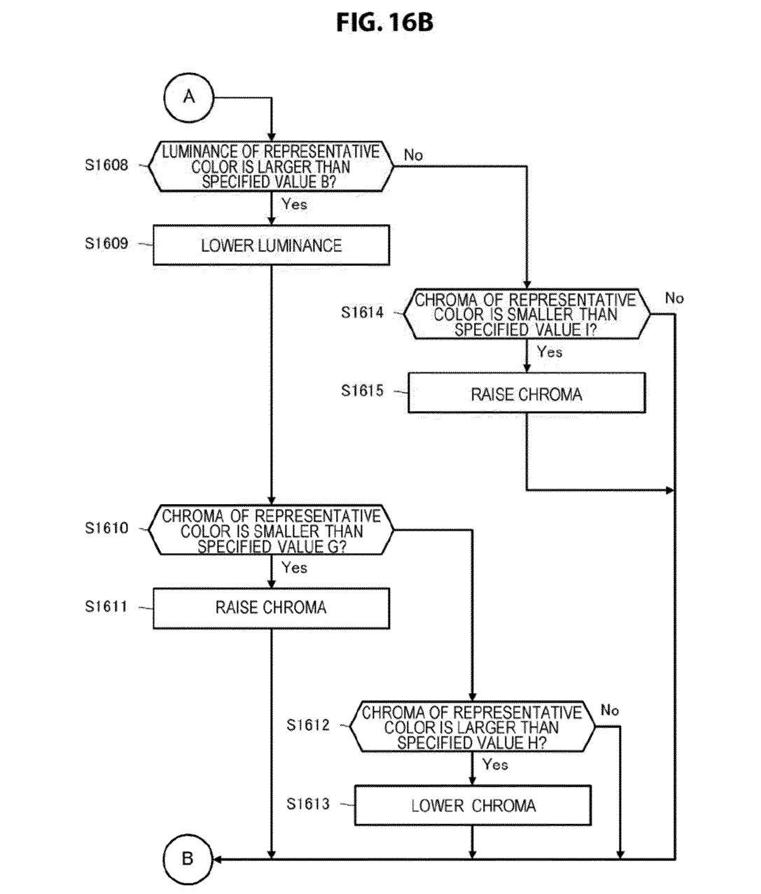

In addition, in FIGS. 16A and 16B, a processing procedure for the background image generation section 1405 to determine a character color of a character string to be displayed as the background image is illustrated in a form of a flow chart.

The background image generation section 1405, first, checks whether a representative picture (or thumbnail thereof) exists in the content detail screen (main screen) (Step S1601).

Here, when no representative picture exists in the content detail screen (No of Step S1601), the background image generation section 1405 configures a specified color as the character color (Step S1602), and terminates the present processing routine.

In addition, when the representative picture exists in the content detail screen (Yes of Step S1601), the background image generation section 1405 extracts a representative color from the representative picture (Step S1603). The representative color is an average of a pixel value of the representative picture or an average of a pixel value of a specific area such as a background part in the representative picture or the like, for example. As a matter of course, other extraction methods may be used.

Then, the background image generation section 1405 checks whether a luminance of the representative color extracted in Step S1603 is smaller than a specified value A (Step S1604).

When the luminance of the representative color is smaller than the specified value A (Yes of Step S1604), the background image generation section 1405 performs adjustment to raise the luminance of the representative color (Step S1605). Next, the background image generation section 1405 checks further whether a chroma of the representative color is larger than a specified value F (Step S1606). Then, when the chroma of the representative color is larger than the specified value F (Yes of Step S1606), the background image generation section 1405 performs adjustment to lower the chroma of the representative color, and the color is made to be the character color (Step S1607).

On the other hand, when the luminance of the representative color is not smaller than the specified value A (No of Step S1604), the background image generation section 1405 checks further whether the luminance of the representative color is larger than a specified value B (where, A<B) (Step S1608).

When the luminance of the representative color is larger than the specified value B (Yes of Step S1608), the background image generation section 1405 performs adjustment to lower the luminance of the representative color (Step S1609). Next, the background image generation section 1405 checks further whether the chroma of the representative color is smaller than a specified value G (Step S1610). Then, when the chroma of the representative color is smaller than the specified value G (Yes of Step S1610), the background image generation section 1405 performs adjustment to raise the chroma of the representative color, and the color is made to be the character color (Step S1611).

In addition, when the chroma of the representative color is not smaller than the specified value G (No of Step S1610), the background image generation section 1405 checks further whether the chroma of the representative color is larger than the specified value H (where, G<H), (Step S1612). Then, when the chroma of the representative color is larger than the specified value H (Yes of Step S1612), the background image generation section 1405 performs adjustment to lower the chroma of the representative color, and the color is made to be the character color (Step S1613).

In addition, when the luminance of the representative color is not larger than the specified value B (No of Step S1608), the background image generation section 1405, checks further whether the chroma of the representative color is smaller than a specified value J (Step S1614). Then, when the chroma of the representative color is smaller than the specified value J (Yes of Step S1614), the background image generation section 1405 performs adjustment to raise the chroma of the representative color, and the color is made to be the character color (Step S1615).

In this way, the intention for the background image generation section 1405 to adjust the luminance and chroma of the representative color, since the information on the screen displayed as the foreground becomes difficult to be seen when the character color of the background image is deep, and the character string of the background image is not able to be read when the character color is light to the contrary, is in avoiding these situations.

As mentioned above, the technology disclosed in the present specification has been described in detail with reference to a specific embodiment. However, it is obvious that those skilled in the art can make modifications and substitutions of the embodiment within the scope not departing from the substance of technologies disclosed in the present specification.

In the present specification, although embodiments where technologies disclosed in the present specification are realized by executing predetermined applications in the information terminal (a smart phone, a tablet and a digital book and the like) coordinated with a television receiver have been described mainly, substances of technologies disclosed in the present specification are not limited to these. As a matter of course, technologies disclosed in the present specification are realizable also by the same applications being executed in the television receiver main body. Alternatively, technologies disclosed in the present specification are realizable also by implementing dedicated hardware in the information terminal or television receiver main body.

In addition, in the present specification, although embodiments where the background image is drawn in the content detail screen which slides in a right and left direction have been described mainly, technologies disclosed in the present specification are applicable in the same way even in a case of sliding in other directions including a vertical direction.

Basically, technologies disclosed in the present specification have been described based on configuration that is exemplification, and the described contents of the present specification should not be construed restrictively. In order to determine substances of technologies disclosed in the present specification, Claims should be taken into consideration.

Additionally, the present technology may also be configured as below.

(1) An information display apparatus including:

an information acquisition section configured to acquire foreground information displayed on a foreground;

a foreground screen generation section configured to generate a foreground screen based on the foreground information;

a character string acquisition section configured to acquire character strings of one or more lines related to the foreground information;

a background image generation section configured to generate a background image in which character strings acquired by the character string acquisition section are drawn; and

an image combination section configured to superimpose the foreground screen on the background image, and generate a display screen.

(2) The information display apparatus according to (1), wherein

the information acquisition section is further configured to acquire detailed information on predetermined content, and

the foreground screen generation section is further configured to generate a content detail screen based on the detailed information on the predetermined content.

(3) The information display apparatus according to (1), wherein

the information acquisition section is further configured to acquire detailed information on predetermined content, and

the character string acquisition section is further configured to acquire predetermined character strings of one or more lines from among the detailed information on the predetermined content.

(4) The information display apparatus according to (3), wherein

the information acquisition section is further configured to acquire detailed information on content related to a program as the foreground information, and

the character string acquisition section is further configured to acquire a character string of a line corresponding to a main title of the program, a subtitle (provided that a subtitle is present), or a date from the detailed information on content related to the program.

(5) The information display apparatus according to (1), further including:

an operation information acquisition section configured to acquire information related to a user's sliding operation on the foreground screen,

wherein the background image generation section is further configured to generate a background image to scroll in accordance with sliding of the foreground screen.

(6) The information display apparatus according to (1),

wherein the background image generation section is further to configured to determine at least a character size, length, or display position of the character strings displayed on the background image.

(7) The information display apparatus according to (6),

wherein the background image generation section is further configured to determine at least a character size or length of each line by multiplying a height and width of an effective display area of the foreground screen by respective predetermined ratios.

(8) The information display apparatus according to (6),

wherein the background image generation section is further configured to cut only excessive number of characters from a character string of length exceeding the determined length of each line.

(9) The information display apparatus according to (6),

wherein the background image generation section is further configured to determine an initial drawing position of a background image for every line, which has respective predetermined ratios with respect to a height and width of an effective display area of the foreground screen.

(10) The information display apparatus according to (9), further including:

an operation information acquisition section further configured to acquire information related to a user's sliding operation on the foreground screen,

wherein the background image generation section is further configured to draw a background image for every line in each initial drawing position in a foreground screen slid to the leftmost end, and carry out drawing so that a right end of a background image of each line is in line with a right end of an effective display area of a foreground screen in a foreground screen slid to the rightmost end.

(11) The information display apparatus according to (10),

wherein the background image generation section is further configured to determine a drawing position of a background image for every line in each slide position of a foreground image in accordance with a number of steps with which the foreground image slides in a right and left direction.

(12) The information display apparatus according to (1),

wherein the background image generation section is further configured to determine a character color of a character string displayed on a background image based on color information which the foreground image has.

(13) The information display apparatus according to (12), wherein

the foreground information includes image information, and

the background image generation section is further configured to determine the character color based on a representative color of the image information.

(14) The information display apparatus according to (13),

wherein the background image generation section is further configured to process the character color based on at least one of a luminance and chroma of the representative color.

(15) The information display apparatus according to (2),

wherein the information acquisition section is further configured to acquire detailed information of broadcast content from data broadcast.

(16) The information display apparatus according to (2),

wherein the information acquisition section is further configured to acquire detailed information of commercial content from a storage medium.

(17) The information display apparatus according to (1), wherein the information acquisition section is further configured to acquire the foreground information from the Internet.

(18) The information display apparatus according to (1),

wherein the character string acquisition section is further configured to acquire a character string associated with the foreground information from the Internet.

(19) The information display apparatus according to (1), further including,

a display section configured to display a display screen where the background image is combined by the image combination section.

(20) An information display method including:

acquiring foreground information displayed on a foreground;

generating a foreground screen based on the foreground information;

acquiring character strings of one or more lines based on the foreground information;

generating a background image in which character strings acquired by the character string acquisition section is drawn; and

generating a display screen by superimposing the foreground screen on the background image.

(21) A computer program written in a computer readable format so as to make a computer function as:

an information acquisition section configured to acquire foreground information displayed on a foreground;

a foreground screen generation section configured to generate a foreground screen based on the foreground information;

a character string acquisition section configured to acquire character strings of one or more lines based on the foreground information;

a background image generation section configured to generate a background image in which a character string for every line acquired by the character string acquisition section is drawn; and

an image combination section configured to generate a display screen by superimposing the foreground screen on the background image.

What is claimed is:

1. An information display apparatus comprising:
an information acquisition section configured to acquire foreground information displayed on a foreground;
a foreground screen generation section configured to generate a foreground screen based on the foreground information;
a character string acquisition section configured to acquire character strings of one or more lines based on the foreground information;
a background image generation section configured to generate a background image in which character strings acquired by the character string acquisition section are drawn; and
an image combination section configured to superimpose the foreground screen on the background image, and generate a display screen.

2. The information display apparatus according to claim 1, wherein
the information acquisition section is further configured to acquire detailed information on predetermined content, and
the foreground screen generation section is further configured to generate a content detail screen based on the detailed information on the predetermined content.

3. The information display apparatus according to claim 1, wherein
the information acquisition section is further configured to acquire detailed information on predetermined content, and
the character string acquisition section is further configured to acquire predetermined character strings of one or more lines from among the detailed information on the predetermined content.

4. The information display apparatus according to claim 3, wherein
the information acquisition section is further configured to acquire detailed information on content related to a program as the foreground information, and
the character string acquisition section is further configured to acquire a character string of a line corresponding to a main title of the program, a subtitle (provided that a subtitle is present), or a date from the detailed information on content related to the program.

5. The information display apparatus according to claim 1, further comprising:
an operation information acquisition section configured to acquire information related to a user's sliding operation on the foreground screen,
wherein the background image generation section is further configured to generate a background image to scroll in accordance with sliding of the foreground screen.

6. The information display apparatus according to claim 1,
wherein the background image generation section is further to configured to determine at least a character size, length, or display position of the character strings displayed on the background image.

7. The information display apparatus according to claim 6,
wherein the background image generation section is further configured to determine at least a character size or length of each line by multiplying a height and width of an effective display area of the foreground screen by respective predetermined ratios.

8. The information display apparatus according to claim 6,
wherein the background image generation section is further configured to cut only excessive number of characters from a character string of length exceeding the determined length of each line.

9. The information display apparatus according to claim 6,
wherein the background image generation section is further configured to determine an initial drawing position of a background image for every line, which has respective predetermined ratios with respect to a height and width of an effective display area of the foreground screen.

10. The information display apparatus according to claim 9, further comprising:
an operation information acquisition section further configured to acquire information related to a user's sliding operation on the foreground screen,
wherein the background image generation section is further configured to draw a background image for every line in each initial drawing position in a foreground screen slid to the leftmost end, and carry out drawing so that a right end of a background image of each line is in line with a right end of an effective display area of a foreground screen in a foreground screen slid to the rightmost end.

11. The information display apparatus according to claim 10,
wherein the background image generation section is further configured to determine a drawing position of a background image for every line in each slide position of a foreground image in accordance with a number of steps with which the foreground image slides in a right and left direction.

12. The information display apparatus according to claim 1,
wherein the background image generation section is further configured to determine a character color of a character string displayed on a background image based on color information which the foreground image has.

13. The information display apparatus according to claim 12, wherein
the foreground information includes image information, and
the background image generation section is further configured to determine the character color based on a representative color of the image information.

14. The information display apparatus according to claim 13,
wherein the background image generation section is further configured to process the character color based on at least one of a luminance and chroma of the representative color.

15. The information display apparatus according to claim 2,
wherein the information acquisition section is further configured to acquire detailed information of broadcast content from data broadcast.

16. The information display apparatus according to claim 2,
wherein the information acquisition section is further configured to acquire detailed information of commercial content from a storage medium.

17. The information display apparatus according to claim 1,
wherein the character string acquisition section is further configured to acquire a character string associated with the foreground information from the Internet.

18. The information display apparatus according to claim 1, further comprising,
a display section configured to display a display screen where the background image is combined by the image combination section.

19. An information display method comprising:
acquiring foreground information displayed on a foreground;
generating a foreground screen based on the foreground information;
acquiring character strings of one or more lines based on the foreground information;
generating a background image in which character strings acquired by the character string acquisition section is drawn; and
generating a display screen by superimposing the foreground screen on the background image.

20. A computer program written in a computer readable format so as to make a computer function as:
an information acquisition section configured to acquire foreground information displayed on a foreground;
a foreground screen generation section configured to generate a foreground screen based on the foreground information;
a character string acquisition section configured to acquire character strings of one or more lines based on the foreground information;
a background image generation section configured to generate a background image in which a character string for every line acquired by the character string acquisition section is drawn; and
an image combination section configured to generate a display screen by superimposing the foreground screen on the background image.
